(19) United States
(12) Patent Application Publication
(10) Pub. No.: US 2008/0017555 A1
(43) Pub. Date: Jan. 24, 2008

(54) SIEVE AND PAN CLEANER DEVICE

(76) Inventor: Andreas Schumacher, Orchard Park, NY (US)

Correspondence Address: DEBORAH E. MORROW, 3721 S. WOODLAND AVENUE, INDEPENDENCE, MO, 64052, US

(21) Appl. No.: 11/459,354

(22) Filed: Jul. 23, 2006

(51) Int. Cl. B07B 1/50

(52) U.S. Cl. 209/379

(57) ABSTRACT

A sieve box for the particle separation process is composed of a box with a pan, a mesh covering, and at least one cleaning device. The cleaning device serves a dual purpose brushes or knobs bounce against the mesh covering while the leg portion continually moves particulate in the pan.

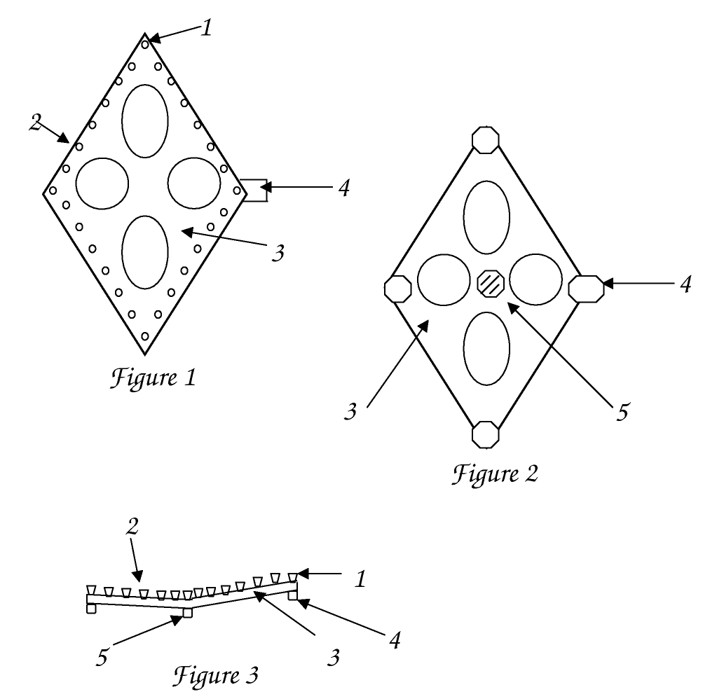

### FIELD OF INVENTION

The invention relates to a tool used in a plansifter to assist in the dry particle separation by cleaning the sieve covering as well as enabling the movement of the dry particles from one section to another. With conventional sieve cleaners, the cleaning devices are in periodic contact with the mesh covering. These cleaners are designed to clean both the mesh covering and move particulate through the pan.

The current sieve box, designed to use a dual action cleaner, contains a frame, sieve covering, box, and a pan. In one device, the sieve cleaner is a three-arm style made from a polyurethane plastic material with natural brush-like bristle or knob-like bumps. This device also contains a polyurethane placeholder at each end of the arms. This placeholder does not allow adequate movement of the device to reach into the corners of the sieve covering. The brush-like bristles or knob-like bumps are place at a 90 degree angle only allowing contain at the top of the bristle or bumps. Thus, the cleaning results in an uneven circular pattern throughout the center leaving the corners blinded with particulate and causing premature wear of the sieve covering as well as decreasing the throughput performance of the sieve.

In a second device, the cleaner is made into a triangular shape a polyurethane plastic material with natural brush-like bristle or knob-like bumps. A radius imposed to create a rounded effect at each of the three protruding ends subdues the triangular shape. This rounding effect causes the device limited movement into the corners of the sieve covering. Thus, the cleaning results in a build-up of particulate in the corners creating a blinding effect and decreasing the throughput performance of the sieve. This device is design to be held under a tension against the sieve covering. By having direct and constant contact with the sieve covering, the cleaning creating considerable wear by cleaning exclusively via a sweeping motion causes premature screen failure.

In both aforementioned devices, the brush-like bristles comprised of either horsehair or hog (pig, swine) hair. The introduction of a natural fiber in a food application introduces the potential of bacteria, oils, and other containments associated with an animal fiber.

The installation process for either of the current cleaner device option is identical. The cleaner device is placed freely in the pan with the sieve covering placed unsecured on top creating the working sieve box. During this installation process, the current cleaning devices can move and become lodged between frame support and the pan. Should the cleaning device become lodged, it would render the device immobile and no cleaning action will take place. This immobility of the cleaner will cause sieve cover to blind and no particle movement will occur. In turn, dramatically decreasing overall capacity throughput.

The problems to be solved refer to the fiber of the brush-like bristles and the movement of the cleaner during installation.

### SUMMARY OF THE INVENTION

This invention is of a diamond shape with synthetic brush-like bristles or knob-like bumps protruding from the topside, the bottom contains pan-clearing stabilizers of varying heights with at least one of the stabilizers containing an adhesive material.

The problem associated with the natural brush-like fiber is solved with this invention by the use of a synthetic fiber made to mimic the characteristics of a natural fiber. The synthetic fiber consists of food grade threads thus eliminating the potential for the introduction of the impurities in a food application.

The installation problem is solved by the design aspects of this invention to include a food grade adhesive adhered to at least one of the stabilizers on the bottom of the cleaner. This adhesive is design to temporarily hold the cleaner to the pan during installation. Once the sieve frame and covering are placed on top of the pan to create a working sieve box, the sieve box is then installed in the plansifter. The gyratory movement of the plansifter causes the adhesive to break loose releasing the cleaner to perform its cleaning action.

The design of this invention further solves sieve covering cleaning problems. This invention is of a diamond shape with each end protrusion shaped to a distinct corner with the brush-like bristle or knob-like bump extending to the end. Each bristle or knob is further installed at an angle to allow for maximum contact with the sieve covering at the point of contact. The corner placement of the bristle or knob is able to access into the corners of the sieve covering maximizing cleaning action and maintain the full capacity of the sieve box. Additionally, the angled bristles or knobs along the top perimeter of the cleaning device simulates a angled brushing motion during the movement of the cleaner, thus enhancing, the cleaning effect. This action also allows for a gentle cleaning enabling the sieve covering to last longer when compared to other cleaners.

1. This invention is sieve cleaner for a sieve box with elements a frame with a sieve covering, a box, a bottom with a pan section and a cleaner consisting:
A pliable plastic material with synthetic brush-like bristles or knob-like numbs attached to the perimeter of the topside of the cleaner. The bristle consists of a food grade synthetic fiber to eliminate any introduction of foreign impurities, Bovine Spongiform Encephalopathy (BSE) or Transmissable Spongiform Encephalopathies (TSE) contamination, bacteria, and other animal induced viruses in food applications.
The bristles or knob placement are/is installed at an angle such as to maximize the cleaning effect. The bristle or knob placement reaches into the corners of the sieve covering and the pan allowing access to cleaning the corners for greater overall cleaning of the sieve covering and the pan
Wherein there are stabilizers on the bottom side of the invention of varying heights to create a teeter-totter effect. With at least one of the stabilizers containing a food grade adhesive material to act as an installation tool holding the invention in place during installation and improving the overall performance of cleaning motion due to exact positioning before operation.
Wherein due to improved cleaning of the sieve covering as well as particulate movement in the pan, this invention effectively increases product flow and overall productivity of the plansifter.

2. This invention contains a food grade synthetic bristle installed to eliminate potential introduction of foreign impurities, BSE/TSE contamination, bacteria, and other animal induced viruses in food applications. The bristles or knob placement installed at an angle such as to maximize the cleaning effect. The bristle or knob placement reaches into the corners allowing access to the corners of the sieve covering and the pan.

3. This invention contains stabilizers on the bottom side of the invention of varying heights to create a teeter-totter effect. With at least one of the stabilizers containing a food grade adhesive material to act as an installation tool holding the invention in place during installation and improving the overall performance of cleaning motion due to exact positioning before operation.
